(19) United States
(12) Patent Application Publication
(10) Pub. No.: US 2013/0204640 A1
(43) Pub. Date: Aug. 8, 2013

(54) Test Requirement List for Diagnostic Tests

(71) Applicants: Olav M. Underdal, Kalamazoo, MI (US); Harry M. Gilbert, Portage, MI (US); Alex Portyanko, Kalamazoo, MI (US); Randy L. Mayes, Otsego, MI (US); Gregory J. Fountain, Kalamazoo, MI (US); William W. Wittliff, III, Gobles, MI (US)

(72) Inventors: Olav M. Underdal, Kalamazoo, MI (US); Harry M. Gilbert, Portage, MI (US); Alex Portyanko, Kalamazoo, MI (US); Randy L. Mayes, Otsego, MI (US); Gregory J. Fountain, Kalamazoo, MI (US); William W. Wittliff, III, Gobles, MI (US)

(21) Appl. No.: 13/568,687

(22) Filed: Aug. 7, 2012

Related U.S. Application Data
(63) Continuation-in-part of application No. 12/108,126, filed on Apr. 23, 2008, now Pat. No. 8,239,094.

(51) Int. Cl. G06Q 50/24; G06Q 10/10

(52) U.S. Cl. CPC G06Q 50/24; G06Q 10/10
USPC 705/3

(57) ABSTRACT

A diagnostic system for a patient includes a memory receiving and storing patient specific information, and storing diagnostic test requirements of a plurality of diagnostic sequences, and a processor identifying the test requirements for a selected diagnostic sequence according to the patient specific information in advance of executing the diagnostic sequence.

### CLAIM OF PRIORITY

This application is a continuation-in-part, and claims the benefit of, U.S. patent application Ser. No. 12/108,126 filed Aug. 7, 2012, entitled TEST REQUIREMENT LIST FOR DIAGNOSTIC TESTS, the disclosure of which is incorporated herein by reference in its entirety.

### TECHNICAL FIELD

The present disclosure relates generally to diagnostic equipment and method thereof. More particularly, the present disclosure relates to diagnostic test requirement list for diagnostic equipment and method thereof.

### BACKGROUND OF THE DISCLOSURE

Computerized diagnostic equipment has become prevalent in many areas such as, for example, healthcare and mechanical systems maintenance including: aircraft; motor vehicles; appliances; and the like. Present external diagnostic and display apparatus, known as diagnostic tools, are commonly limited to reporting only a subset of data gathered on the test subject (e.g., person, other animal, device, etc.). For example, the diagnostic tool may only be able to display the data gathered by the diagnostic tool itself or may only be able to display historical data. Increasingly, subtle subsystem failures in test subjects overload the ability of medical or maintenance technicians, not simply to read the faults detected and stored by the diagnostic tools themselves, but to combine those readings with peripheral measurements and deduce corrective actions with both speed and accuracy.

In the medical industry, diagnostic systems provide for monitoring body functions, imaging capabilities, real-time and historical data, and diagnosis of medical conditions, as well as system diagnostics to detect anomalies in the medical equipment. Combining and visualizing these disparate data sets may improve diagnostics but is beyond the capabilities of conventional diagnostic systems. Including and beyond medical diagnostic issues, in general, diagnostic systems are used by technicians and professionals in virtually all industries to perform basic and advanced system testing functions. For example, in the automotive, trucking, heavy equipment and aircraft industries, diagnostic test systems provide for vehicle onboard computer fault or trouble code display as mentioned above, interactive diagnostics, multiscope and multimeter functions, and electronic service manuals.

When diagnostic tests are performed, a user must have certain tools to perform the test. However, it is difficult with current diagnostic systems to be properly prepared for such diagnostic tests. Further, it is difficult to check whether the user can actually perform the test and in an efficient manner. Therefore, the judgment is left to each individual user and their expertise. It is difficult to obtain consistency in the diagnostics and treatment from one technician to another. There is a need to have a technique and system that will accommodate for a greater efficiency that is not dependent upon the technician performing the diagnostics and treatment. Further, there is a need to properly organize resources needed ahead of time to perform certain tests and diagnostic methods.

### SUMMARY OF THE DISCLOSURE

The foregoing needs are met, to a great extent, by the present disclosure, wherein one aspect a technique and apparatus are provided that will allow a technician to use a diagnostic system that provides a list of requirements to support a diagnostic test in advance of the test being performed, thus allowing for a greater efficiency and consistency of the diagnostics.

An embodiment of the present invention pertains to a diagnostic system for a patient. The system includes a remote database, memory, and processor. The remote database includes diagnostic test requirements. The memory is separate from the remote database. The memory receives and stores patient specific information, and stores diagnostic test requirements for each sequential step of a plurality of diagnostic sequences received from the remote database. The processor is connected to the memory and identifies a list of diagnostic test requirements for a selected diagnostic sequence according to the patient specific information in advance of executing the selected diagnostic sequence.

Another embodiment of the present invention relates to a method for a patient diagnostics. In this method, a test or sequence of medical procedures is stored in a database of a diagnostic tool, a processor of the diagnostic tool is used to correlate the test or sequence of medical procedures with a list of test requirements for each sequential step of the test or sequence of medical procedures, and patient specific information is received from an input device of the diagnostic tool. The processor identifies the list of test requirements according to the patient specific information and the correlated test or sequence of medical procedures and a diagnostic test or medical procedure is performed on the patient according to the patient specific information and the identified list of test requirements.

Yet another embodiment of the present invention pertains to a patient diagnostics system. The system includes a means for storing, means for correlating, means for receiving, means for identifying, and a means for performing. The means for storing is to store a test or sequence of medical procedures in a database. The means for correlating is to correlate the test or sequence of medical procedures with a list of test requirements for each sequential step of the test or sequence of medical procedures. The means for receiving is to receive patient specific information. The means for identifying is to identify a list of test requirements according to the patient specific information, and the correlated test or sequence of medical procedures. The means for performing is to perform a diagnostic test or medical procedure on the patient according to the patient specific information and the identified list of test requirements.

In addition, according to an aspect of the present disclosure, a diagnostic system for a device or appliance, includes a diagnostic tool including a first memory, receiving device specific information and performing a diagnostic test on the device, storing the test result in the first memory, and a second memory in communication with the diagnostic tool, storing the test result in the database, the second memory providing a feedback of the test result to the diagnostic tool by transferring the information on the database to the diagnostic tool, correlating the feedback information into the diagnostic test procedure of the diagnostic tool.

The diagnostic system can also include a manufacturer facility receiving information from the database and modifying the information back to the database. The diagnostic system can also include a repair facility receiving information from the database and modifying the information back to the database. The diagnostic system can also include the database receiving customer feedback information by identifying the symptom of the vehicle not being repaired, the feedback information of the customer being transferred to the diagnostic tool for correlation with diagnostic procedures.

The diagnostic system can also include the database receiving external feedback information by identifying the symptom of the device not being repaired, the external feedback information being transferred to the diagnostic tool for correlation with diagnostic procedures. The diagnostic system can also include the database including diagnostic test information with the fields of age of the component, region of failure and the device. The diagnostic system can also include the second memory being separate from the diagnostic tool.

The diagnostic system can also include the second memory being integrated with the diagnostic tool. The diagnostic system can also include the database including a termination of a diagnostic session and manual completion of the diagnostics, with the manual completion of the diagnostics extending the logic of the diagnostic system.

The diagnostic system can also include the extension of the logic being provided after posting of a service bulletin for a certain period of time and receiving feedback from the service bulletin. The diagnostic system can also include the diagnostic tool receives feedback of design issues of the vehicle and recurring failures of the identified device.

In another aspect of the disclosure, a method for a device diagnostics, includes receiving device specific information, performing a diagnostic test on the device according to the device specific information, storing the diagnostic test result, and providing a feedback of the diagnostic test result by correlating the feedback information into the diagnostic test procedure for the next diagnostic test of the device.

In another aspect of the disclosure, a diagnostic system for a device , includes a diagnostic means including a first memory means, receiving device specific information and performing a diagnostic test on the device, storing the test result in the first memory means, and a second memory means in communication with the diagnostic means, storing the test result in the database, the second memory providing a feedback of the test result to the diagnostic means by transferring the information on the database to the diagnostic means, correlating the feedback information into the diagnostic test procedure of the diagnostic means.

There has thus been outlined, rather broadly, certain embodiments of the disclosure in order that the detailed description thereof herein may be better understood, and in order that the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a diagram of the system producing a list requirement.

FIG. 2 is a flow diagram of the diagnostic tests producing a list of requirements.

FIG. 3 is another flow diagram producing a list of necessary or optional resources for a repair or diagnostic tests.

FIG. 4 is a block diagram of the computer of FIG. 1.

FIG. 5 is a block diagram of the components of the diagnostic tool of FIG. 1.

FIG. 6 is a view illustrating a connection between a vehicle and a diagnostic tool or personal computer of FIG. 1.

FIG. 7 is a block diagram of a system architecture for a diagnostic system in accordance with another embodiment of the invention.

FIG. 8 is a flow diagram of the diagnostic tests producing a list of requirements according to the embodiment of FIG. 7

### DETAILED DESCRIPTION

The disclosure will now be described with reference to the drawing figures, in which like reference numerals refer to like parts throughout. In general, the various embodiments are directed towards diagnosing mechanical devices and humans and other animals. An embodiment in accordance with the present disclosure provides an apparatus and method that will allow a user, such as a technician, to use a computer or diagnostic equipment to generate a list of resources needed to complete the diagnostic procedure. Another embodiment in accordance with the present disclosure provides an apparatus and method for medical personnel to utilize a computer or diagnostic equipment to generate a list of resources needed to complete the diagnostic procedure.

For each step in a diagnostic sequence, certain test requirements, e.g., tools, parts, facilities, training, etc., required to complete that step can be identified. Having the test requirements can permit advanced planning for a diagnostic step and/or the entire diagnostic sequence. Taken further, this information can permit a repair facility to schedule certain testing and repairs based on availability of test requirements. Additionally, this information can permit a repair facility to plan its inventory and environment regarding these test requirements in advance to be able to support said diagnostic tests and repairs.

Moreover, this information can facilitate training in the use of these test requirements to certify levels of competence in certain tests and repairs. The availability of these test requirements can result in a given facility being certified to perform certain diagnostic tests and repairs.

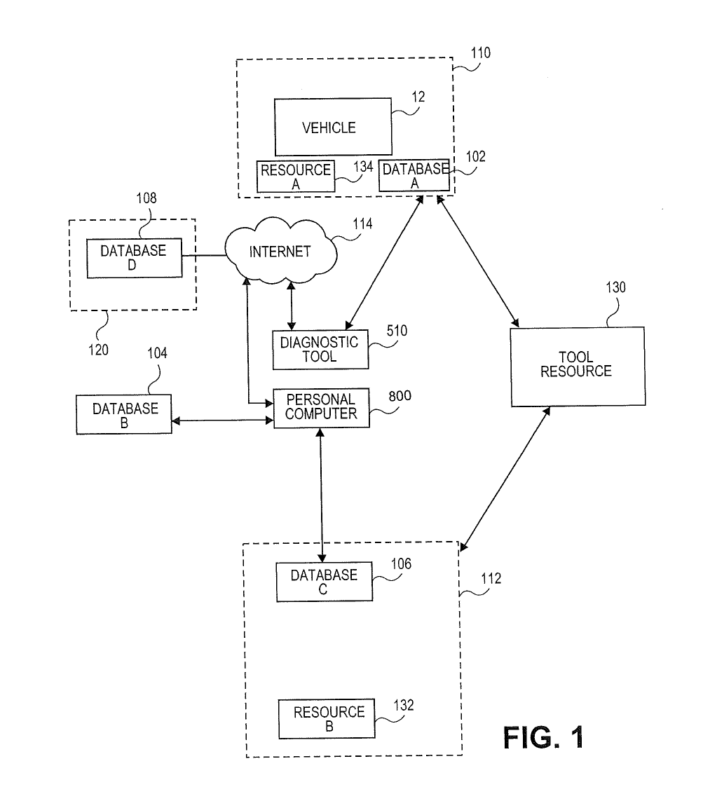

Referring to FIG. 1, a database 102 (database A) of test requirements will be maintained at a repair facility 110. The database is not limited to being located at the repair facility 110, as it can be at any location where the diagnostic tests are performed, or the database can be remotely located at the manufacturer's facility or third party vendor facility 112 as seen in database C 106. The database with the test requirements can also be on an independent server 120 on the Internet 114, as seen for example on database D 108. As seen in database B 104, the database with test requirements can be on a memory unit remote from the repair facility 110, or manufacturing facility 112, and the database B 104 is not connected directly to the Internet 114 or other network.

The test requirements can then be optionally associated with a diagnostic or repair step in the advanced diagnostic function diagnostic sequence during the authoring of that step. The information from any of the databases holding the pertinent information (102-108) can be the transmitted or uploaded into the diagnostic tool 510 or the personal computer 800.

Alternatively, the test requirement information can be pre-loaded into the memory of the diagnostic tool 510 or personal computer 800 before the authoring of the step and associated within the diagnostic tool 510 or computer 800. In addition, the information of the test requirements can be updated at any time after authoring of the diagnostic sequence.

Characterization of test requirements can be extended to include the cost of establishing a requirement, or other related criteria or variable or constant related to the specific test requirement. In this manner, the test requirement becomes a component of the overall diagnostic cost, and is factored into the employed optimization algorithm.

For example, a test requirement of a screw driver can include the cost often United States dollars. Other extensions can be linked resources, such as a tool that requires an additional technician. Therefore, tool “X” will require an additional technician to get the diagnosis or repair completed. Additional extensions can be, for example, the level of expertise of the technician, or the availability of the technician or the tool in the tool box 130. The requirements list may be used to show that the hammer is not in tool resource 130, but in resource B 132 at the manufacturing facility 112. Therefore, the location of the resource can be added to the list. The factors of location or the availability of the resource can then be factored into the optimization algorithm employed in the diagnosis or repair of a vehicle 12. In addition, although the term, ‘vehicle’ is used throughout in the description of FIGS. 1-6, the embodiments of the invention are not limited to vehicles, but rather, embodiments may be utilized in the service and repair of any suitable device. Examples of suitable devices include appliances, such as washers and dryers, refrigerators, stoves, freezers, dish washers, air conditioners, gadgets, tools, equipment, and the like.

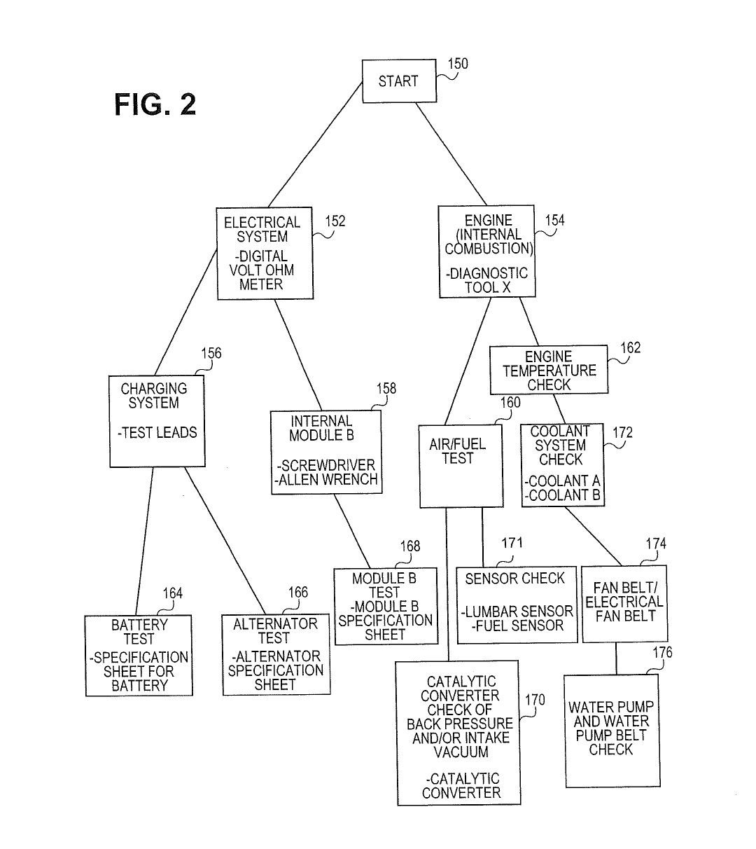

Referring to FIG. 2, a diagnostic chart can be generated. Therefore, there would be a plurality of steps that would each generate a list of test requirements. A technician or user would use the diagnostic tool 510 or a personal computer 800 or other computing device, or even device embedded in the vehicle 12. The user would start the diagnostic tool 510, for example, and then choose for a list of options in a menu or manually type in the diagnostic steps needed at step 150. The vehicle specific information can be entered manually or automatically inputted from the vehicle 12. Then, the user can select a diagnostic sequence or repair of the electrical system 152. The test requirements list would include a digital volt ohmmeter that is necessary for the pre-programmed different types of sequences. The cost of the digital volt ohmmeter can also be generated and displayed. Then, the user can select to test the charging system, which would give the requirement of test leads at step 156. Then, the user can select a battery test 164, which would give a specification sheet for the battery. The diagnostic tool 510 can indicate the sheet needed, or actually provide or include the sheet on the battery, or the location of the information. The user can also, instead choose to test the alternator 166, which would give the option of the alternator specification sheet. The information on the alternator can also be stored on the diagnostic tool itself, but if update is needed, the updated current information can be cited to its location.

The user can also select an internal module B 158 that is located in a position in the vehicle that may require extra steps to get to. Therefore, the test requirements can show a screwdriver and the Allen wrench. The list can also include the feature of “optional” or “required” in its extension of the resource list. Then in step 168, the module B specification sheet can be indicated or used.

Alternatively, the user can select to test or repair the engine. Then, the list on step 154 can indicate a test requirement of an additional diagnostic tool, such as diagnostic tool “X”, that is needed in addition to the diagnostic tool 510 being used. The user can then select to do an air/fuel test 160, which leads to a check of the sensor 171 or the catalytic converter 170 depending on certain factors or entries into the diagnostic tool 510. If the sensor check is selected, then the list can produce the sensor that may need replacing, such as lambda sensor or the fuel sensor. An option indicator can be included to have the resource at hand by indicating its model number, if the sensor needs replacement. If the catalytic converter 170 is selected, then there can be a check of the backpressure or intake. The requirements list can generate a list of the catalytic converter and the model and type of converter that is needed. Additionally, there can be attached a statistical likelihood of needing the part depending on the test. For example, if it is known that a certain result has a 10 percent chance of needing a replacement of the catalytic converter when the backpressure is below a certain value. Alternatively, if the catalytic converter does not need replacement, a certain tool can be in the list to clear the passage leading to the catalytic converter.

The user can also select to check the engine temperature 162, and then the user can check the coolant system check 172. The list then produces two types of coolant and list when to use either coolant A or coolant B or under what conditions. Then, the fan belt or the electrical of the fan can be checked 174. Thereafter, the water pump and water pump belt can be checked 176. In both step 174 and 176, there can be a generation of the requirements needed, and additional conditions connected to the requirements, such as cost, location, etc., of the individual or group of requirements.

The user can select any level of the diagnostic sequence to see what is needed. For example, if the technician does not know what to check exactly or what exact sequence, but only knows of a certain symptom, then the symptom can entered and all the test requirements under all the steps can be generated. For example, if a symptom under the electrical system is chosen, then the test requirements of: digital volt-ohmmeter; test leads; screw driver; Allen wrench; the specification sheets for the battery; alternator; and module B are generated.

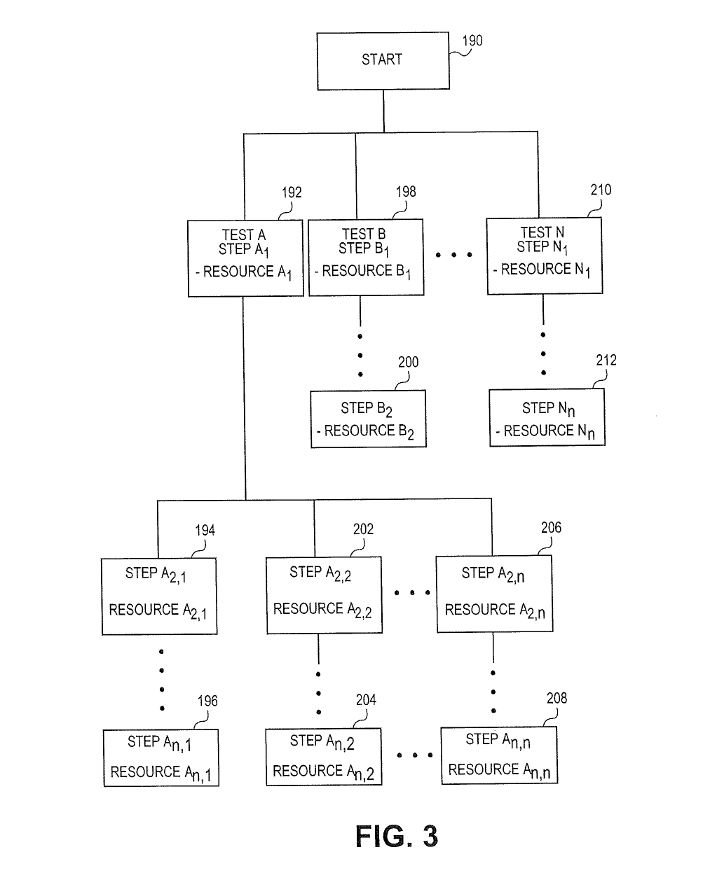

Referring to FIG. 3, the test requirement resources can be generated for any type of diagnostic or repair sequence. The user starts 190 by selecting the symptom to be tested or the area of the vehicle to be tested. Therefore, the user can select test A 192, test B 198, all the way up to test N 210, where N is an integer greater than 2. Then, when step A is selected, a plurality of steps A1 to An 192-196 can be performed, which each step generating a resource requirement from A1 to An, where n is an integer greater than 2.

When test A is selected, the steps can also be alternatively step A_{2,2} 202, all the way up to step A_{2,n} 206. Step A_{2, 1}194 can generate resource A_{2, 1}, while step A_{2, 2} 202 generates resource A_{2,2}, and step A_{2,n} can generate resource A_{2,n} 206. The steps can be further expanded into steps A_{n, 1} with resource A_{n, 1} 196, step A_{n,2} with resource A_{n,2} 204 and step A_{n,n} with resource A_{n,n}, where n is a number greater than 2. Furthermore, step B₁ with resource B₁ can be expanded to step B₂ with resource B2 200, and test N with step N₁ and resource N₁ 210 can be expanded to step Nₙ and resource Nₙ 212, where N and n are integers greater than 2. Therefore, as shown in FIG. 3, the possibilities of generating the requirements list are endless. There are pluralities of potential possibilities that can be generated from the list.

The user, as mentioned above, can select any level of the sequence to generate the list, or the level of generation can be pre-selected. For example, if the level at step 194 is limited, then resources A₁, A₂, 1, up to A_{n,1} will be generated. However, if the level at step 192 is selected, then resources A₁ to A_{n, n} will be displayed or generated.

The output of the list is not limited to a display. The output can be displayed or it can be transmitted to another location for view by another user or device. The output of the list can also be transmitted or uploaded to a remote database.

Therefore, as shown in FIGS. 1-3, as the user goes through the steps or instructs the steps for test and/repair of the vehicle 12, trips to the tool box 130 located remotely from the vehicle 12 can be reduced if the list requirement is generated. The user may need a DVOM (digital volt ohmmeter), screwdriver, and test leads. The smart list of the tools or other resources reduces the back and forth needed, thus making the diagnosis more efficient. Additionally, the user is able to plan ahead and thereby reducing the possibility of losing prolonged time in the repair. The user, a day ahead of the test can generate and locate if a certain part is available in the storage warehouse. Further, if additional technicians are needed, then the availability of such technicians can be generated or scheduled ahead of time.

Therefore, the requirements list accommodates a user to schedule the resources that are needed to make the necessary diagnosis and/or repair. The advanced scheduling also allows the diagnosis or repairs to be executed in a more efficient manner and the information can be relayed to the owner of the vehicle, thus providing additional service support for the owner of the vehicle or third party.

As mentioned above, there can also be other resources, such as service manual, wiring manuals, additional help, etc. There can even be at a point of conclusion, a generation of a part number for the failed component, and then go to the parts needed. Separate fields can be included the database. Therefore, the requirements list provides the ingredients list for a recipe. Any type of resources and at any level of the list of resources can be generated.

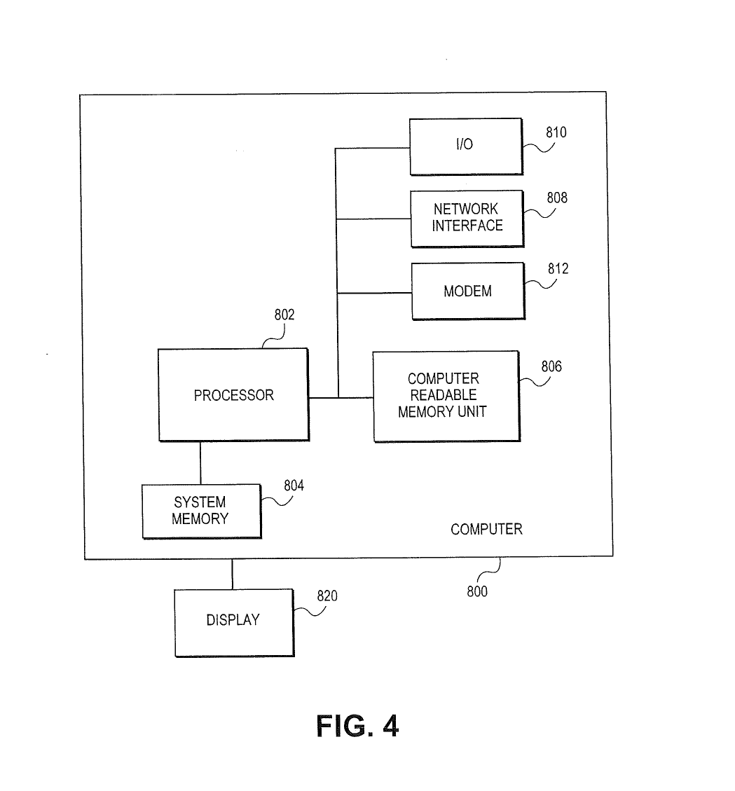

Referring to FIG. 4, an example of the computer 800 of FIG. 1, but not limited to this example of the computer 800, that can read computer readable media that includes computer-executable instructions of the disclosure. The computer 800 includes a processor 802 that uses the system memory 804 and a computer readable memory device 806 that includes certain computer readable recording media. A system bus connects the processor 802 to a network interface 808, modem 812 or other interface that accommodates a connection to another computer or network such as the Internet. The system bus may also include an input and output (I/O) interface 810 that accommodate connection to a variety of other devices. Furthermore, the computer 800 can output through, for example, the I/O 810, data for display on a display device 820.

The disclosure or parts thereof can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present disclosure can include the computer-readable medium having stored thereon a data structure including a plurality of fields containing data representing the techniques of the disclosure.

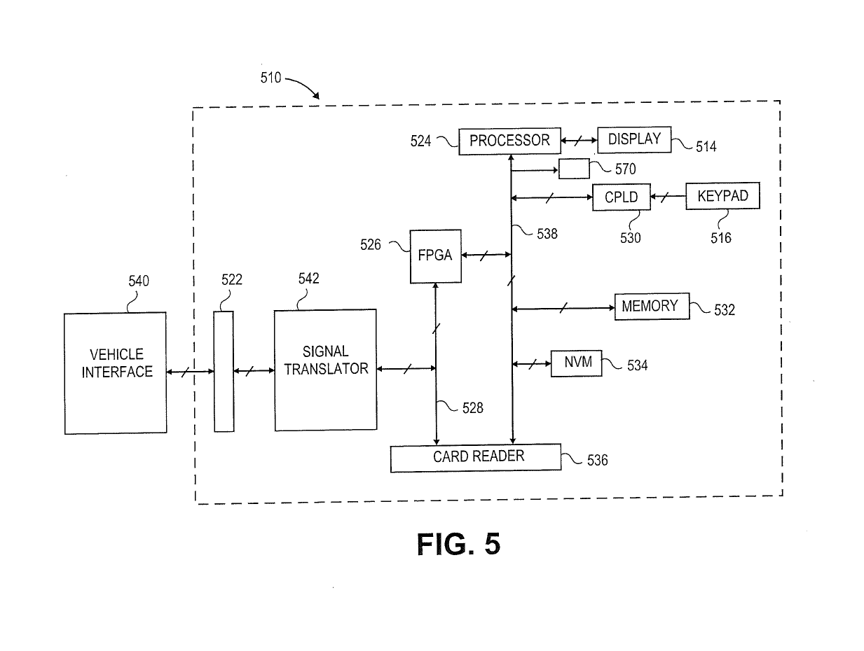

FIG. 5, shows the details of the diagnostic tool 510 of FIG. 1. The diagnostic tool can utilize the DTC's from the onboard computer, and/or check for the vehicle health information. FIG. 5 is a block diagram of the components of a diagnostic tool 510. The diagnostic tool 510, according to an embodiment of the disclosure, includes a processor 524, a field programmable gate array (FPGA) 526, a first system bus 528, the display 514, a complex programmable logic device (CPLD) 530, the user interface 516 in the form of a keypad, a memory subsystem 532, an internal non-volatile memory (NVM) 534, a card reader 536, a second system bus 538, the connector interface 522, and a selectable signal translator 542. A vehicle communication interface 540 is in communication with the diagnostic tool 510 through connector interface 522 via an external cable. The connection between the vehicle communication interface 540 and the connector interface 522 can also be a wireless connection such as BLUETOOTH, infrared device, wireless fidelity (WiFi, e.g. 802.11), etc.

The selectable signal translator 542 communicates with the vehicle communication interface 540 through the connector interface 522. The signal translator 542 conditions signals received from a motor vehicle control unit through the vehicle communication interface 540 to a conditioned signal compatible with the diagnostic tool 510. The translator 542 can communicate with, for example, the communication protocols of J1850 signal, ISO 9141-2 signal, communication collision detection (CCD) (e.g., Chrysler collision detection), data communication links (DCL), serial communication interface (SCI), S/F codes, a solenoid drive, J1708, RS232, controller area network (CAN), or other communication protocols that are implemented in a vehicle.

The circuitry to translate a particular communication protocol can be selected by the FPGA 526 (e.g., by tri-stating unused transceivers) or by providing a keying device that plugs into the connector interface 522 that is provided by diagnostic tool 510 to connect diagnostic tool 510 to vehicle communication interface 540. Translator 542 is also coupled to FPGA 526 and the card reader 536 via the first system bus 528. FPGA 526 transmits to and receives signals (i.e., messages) from the motor vehicle control unit through the translator 542.

FPGA 526 is coupled to the processor 524 through various address, data and control lines by the second system bus 538. FPGA 526 is also coupled to the card reader 536 through the first system bus 528. Processor 524 is also coupled to the display 514 in order to output the desired information to the user. The processor 524 communicates with the CPLD 530 through the second system bus 538. Additionally, the processor 524 is programmed to receive input from the user through the user interface 516 via the CPLD 530. The CPLD 530 provides logic for decoding various inputs from the user of diagnostic tool 510 and also provides the glue-logic for various other interfacing tasks.

Memory subsystem 532 and internal non-volatile memory 534 are coupled to the second system bus 538, which allows for communication with the processor 524 and FPGA 526. Memory subsystem 532 can include an application dependent amount of dynamic random access memory (DRAM), a hard drive, and/or read only memory (ROM). Software to run the diagnostic tool 510 can be stored in the memory subsystem 532. The internal non-volatile memory 534 can be, but not limited to, an electrically erasable programmable read-only memory (EEPROM), flash ROM, or other similar memory. The internal non-volatile memory 534 can provide, for example, storage for boot code, self-diagnostics, various drivers and space for FPGA images, if desired. If less than all of the modules are implemented in FPGA 526, the non-volatile memory 534 can contain downloadable images so that FPGA 526 can be reconfigured for a different group of communication protocols.

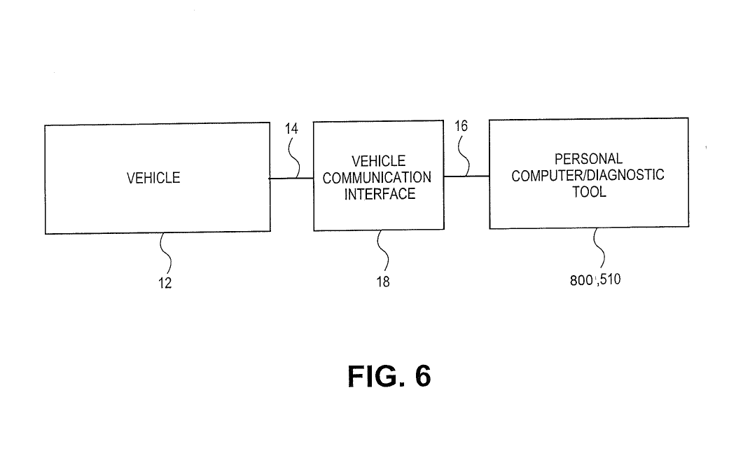

Referring to FIG. 6, the vehicle 12 is shown connected to a personal computer 800 or a dedicated diagnostic tool 510 via a vehicle communication interface 18. The first connection 14 between vehicle 12 and the vehicle communication interface 18, and the second connection 16 between the vehicle communication interface 18 and the personal computer/diagnostic tool 800 and 510 can be either wired or wireless.

Applicable communications with the host, such as the vehicle 12 connected to the computer 800 or diagnostic tool 410, can be maintained during all functions of the vehicle during diagnostics. The connections 14 and 16 can include a wired connection such as through a RS232 port, USB (Universal Serial Bus), Ethernet cable. However, the connections 14 and 16 can also be wireless using protocols such as BLUETOOTH, IEEE 802.11x, wireless USB, other types of wireless Ethernet protocols, etc.

The list displayed on the diagnostic tool 510 or personal computer 800 can be outputted with or without the connection to the vehicle. The vehicle specific information can be inputted manually or automatically through a wired or wireless connection. The list can also be produced without the vehicle specific information. General information can be entered of the vehicle, or no information at all about the vehicle. Any level of the list can be generated. A general requirements list can be generated for all types of vehicle, or a list for a specific type of vehicle.

Although examples of the diagnostic system providing test requirement to support the diagnostic tests, other examples can also be made. For example, other information can be provided in advance of the diagnostic tests. The advanced information can used to support the diagnostic test, or the advance notice of the information can aid in the preparation for the test.

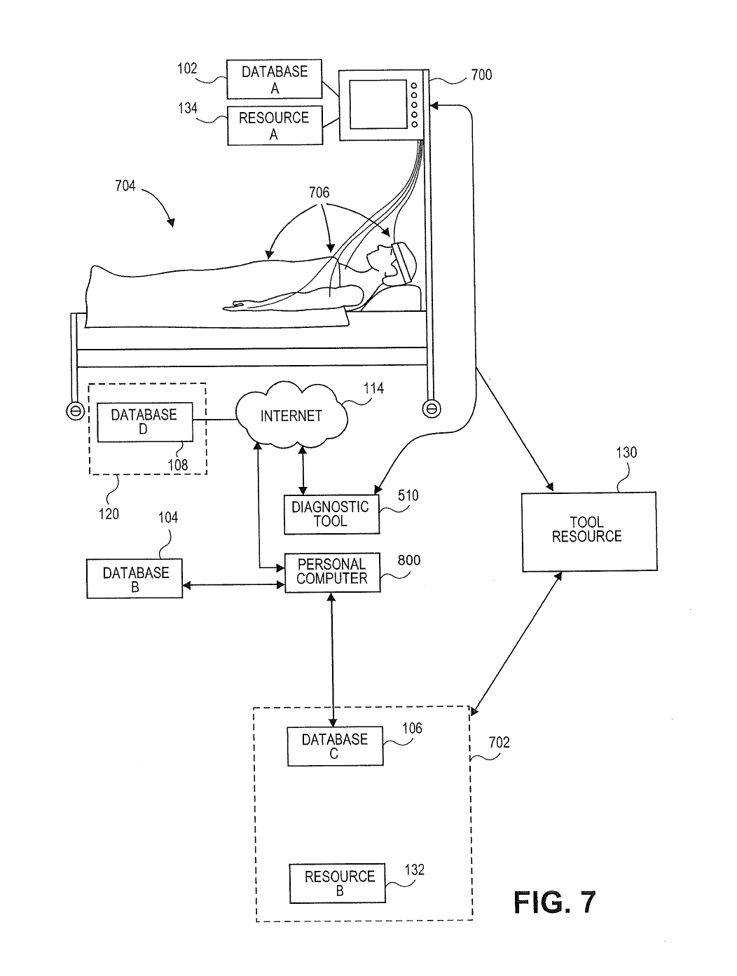

Referring to FIG. 7, the database 102 (database A) of test requirements will be maintained at a bedside unit 700. The database is not limited to being located at the bedside unit 700, as it can be at any location where the diagnostic tests are performed, or the database can be remotely located at the imaging facility or operating room 702 as seen in database C 106. The database with the test requirements can also be on an independent server 120 on the Internet 114, as seen for example on database D 108. As seen in database B 104, the database with test requirements can be on a memory unit remote from the bedside unit 700, or operating room 702, and the database B 104 is not connected directly to the Internet 114 or other network.

The test requirements can then be optionally associated with a diagnostic or treatment step in the advanced diagnostic function diagnostic sequence during the authoring of that step. The information from any of the databases holding the pertinent information (102-108) can be the transmitted or uploaded into the diagnostic tool 510 or the personal computer 800.

Alternatively, the test requirement information can be pre-loaded into the memory of the diagnostic tool 510 or personal computer 800 before the authoring of the step and associated within the diagnostic tool 510 or computer 800. In addition, the information of the test requirements can be updated at any time after authoring of the diagnostic sequence.

Characterization of test requirements can be extended to include the cost of establishing a requirement, or other related criteria or variable or constant related to the specific test requirement. In this manner, the test requirement becomes a component of the overall diagnostic cost, and is factored into the employed optimization algorithm.

For example, a test requirement of a syringe can include the cost of ten United States dollars. Other extensions can be linked resources, such as an instrument that requires an additional technician (such as a phlebotomist). Therefore, tool “X” will require an additional technician to get the diagnosis or treatment completed. Additional extensions can be, for example, the level of expertise of the technician, or the availability of the technician or the equipment in the medical equipment inventory of the tool source 130. The requirements list may be used to show that the scalpel is not in the medical equipment inventory of the tool source 130, but in resource B 132 at the operating room 702. Therefore, the location of the resource can be added to the list. The factors of location or the availability of the resource can then be factored into the optimization algorithm employed in the diagnosis or treatment of the patient 704.

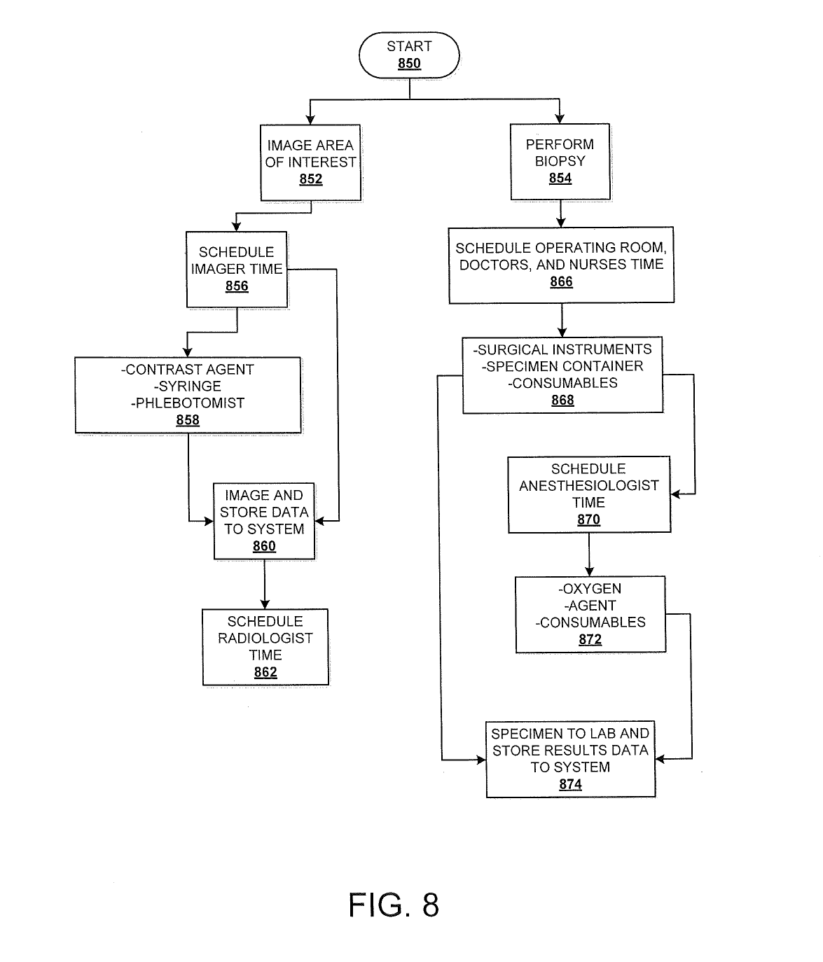

Referring to FIG. 8, a diagnostic chart can be generated. Therefore, there would be a plurality of steps that would each generate a list of test requirements. A user such as a technician or doctor would use the diagnostic tool 510 or a personal computer 800 or other computing device to perform certain diagnostic procedures. The user would start the diagnostic tool 510, for example, and then choose for a list of options in a menu or manually type in the diagnostic steps needed at step 150. The patient 704 specific information, such as medical history, weight, height, etc., can be entered manually or automatically inputted from the patient 704 via the sensors 706, or historical information for the patient 704 may be accessed via a database or Internet 114. Then, the user can select a diagnostic sequence or treatment of the patient 704. For example, if the patient 704 is having issues with a particular organ, the organ may be imaged 852 or biopsied 854. To image the organ, the test requirements list would include imager time that is necessary for the imaging of the patient 704. The cost of the time on the imager can also be generated and displayed. Then, the user can select the images to include (or not) a contrasting agent, which would give the requirement of the contrasting agent, syringe, and phlebotomist at step 858. Then, the user can select where to store the image results 860, which would give selected personnel access to the image data. The diagnostic tool 510 can indicate that a radiologist is needed to read the data and provide a menu to select and schedule time with the radiologist at step 862.

Alternatively or in addition to the imaging, the user can select to perform a biopsy at step 854. Then, the list at step 868, can indicate a test requirement of an additional tools, such as cutting tools, trocars, forceps, sponges, specimen containers and the like that is needed in addition to the diagnostic tool 510 being used. The user can then select to do the procedure with the patient under anesthesia 870, which leads to a list of anesthesiologist consumable, at step 872, depending on certain factors or entries into the diagnostic tool 510. If the anesthesia is selected, then the list of available anesthesiologists may be provided for selection. The requirements list can generate a list of the anesthesiologist consumable, such as oxygen, anesthetic agent, etc., based on the anesthesiologist selected. Additionally, there can be attached a statistical likelihood of needing additional medical staff depending on the procedure. For example, if it is known that a certain procedure has a 10 percent chance of complications when the patient's age or weight is above a certain value.

The user can also select the lab to send the biopsy sample and/or priority of the pathology. For example, if further procedures depend on the pathology results and the patient is to remain under anesthesia and open on the operating table until the pathology is confirmed, the in-hospital lab and highest priority may be given to the sample 874. The list then produces an inventory of all instruments, consumables, other resources, specialist time, costs, and the like. In this manner, the user is aware of what is needed prior to the initiation of the procedure and the necessary equipment and personnel may be available of scheduled.

The user can select any level of the diagnostic sequence to see what is needed. For example, if the technician does not know what to check exactly or what exact sequence, but only knows of a certain symptom, then the symptom can entered and all the test requirements under all the steps can be generated. For example, if a symptom such as a sharp pain in right abdominal area is chosen, then imaging the gastrointestinal tract, laparoscopic biopsy of the vermiform appendix, and all related resources for laparoscopic biopsy is generated.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A diagnostic system for a patient, comprising:
a remote database including diagnostic test requirements;
a memory separate from the remote database, wherein the memory receives and stores patient specific information, and stores diagnostic test requirements for each sequential step of a plurality of diagnostic sequences received from the remote database; and
a processor connected to the memory and identifies a list of diagnostic test requirements for a selected diagnostic sequence according to the patient specific information in advance of executing the selected diagnostic sequence.

2. The diagnostic system of claim 1, wherein the processor permits a medical facility to schedule a diagnostic test or the sequence of medical procedures based on an availability of the listed diagnostic test requirements.

3. The diagnostic system of claim 1, further comprising a medical facility to allocate an inventory and environment for the selected diagnostic sequence in advance of diagnostic test and medical procedures associated with the selected diagnostic sequence.

4. The diagnostic system of claim 1, further comprising a display device connected to the processor to display the diagnostic test requirements including certification of aptitude levels of a user with regard to the selected diagnostic sequence.

5. The diagnostic system of claim 1, wherein the diagnostic test requirements being associated with a diagnostic or medical procedure step in the selected diagnostic sequence.

6. The diagnostic system of claim 1, wherein the diagnostic test requirements include medical instruments, implants, medical equipment, facilities and training.

7. The diagnostic system of claim 1, wherein the diagnostic test requirements includes a cost of a diagnostic test or location of the diagnostic test.

8. The diagnostic system of claim 1, further comprising a display device displaying the diagnostic test requirements, which includes a list of items that are required to perform a given diagnostic or medical procedure of the selected diagnostic sequence, the diagnostic test requirements being generated for any set of diagnostic sequences.

9. A method for a patient diagnosis, comprising the steps of:
storing a test or sequence of medical procedures in a database of a diagnostic tool;
correlating, with a processor of the diagnostic tool, the test or sequence of medical procedures with a list of test requirements for each sequential step of the test or sequence of medical procedures;
receiving patient specific information from an input device of the diagnostic tool;
identifying, with the processor, the list of test requirements according to the patient specific information and the correlated test or sequence of medical procedures; and
performing the sequence of diagnostic test or medical procedure on the patient according to the patient specific information and the identified list of test requirements.

10. The method of claim 9, further comprising permitting a medical facility, via the processor, to schedule the sequence of diagnostic test or medical procedures based on an availability of the listed test requirements.

11. The method of claim 9, further comprising allocating at a medical facility, an inventory and environment for performing the sequence in advance of diagnostic tests and medical procedures.

12. The method of claim 9, further comprising displaying the list of test requirements including the certification of aptitude levels with regard to the sequence of diagnostic tests or medical procedures.

13. The method of claim 9, wherein the list of test requirements being associated with a diagnostic or medical procedure step in the test or sequence of medical procedures.

14. The method of claim 9, wherein the list of test requirements includes medical instruments, implants, medical equipment, facilities and training.

15. The method of claim 9, wherein the list of test requirements includes a cost of the test requirements.

16. The method of claim 9, wherein the list of test requirements further comprising a list of items that are required to perform a given test or medical procedure.

17. A patient diagnostics system, comprising:
means for storing a database including a test or sequence of medical procedures;
means for correlating the test or sequence of medical procedures with a list of test requirements for each sequential step of the test or sequence of medical procedures;
means for receiving patient specific information;
means for processing a list of test requirements according to the patient specific information, and the correlated test or sequence of medical procedures; and
means for performing a the test or sequence of medical procedures on the patient according to the patient specific information and the identified list of test requirements.

18. The diagnostic system of claim 17, further comprising means for permitting a medical facility to schedule the test or sequence of medical procedures based on an availability of the listed test requirements.

19. The diagnostic system of claim 17, further comprising a medical facility to allocate an inventory and environment for performing the sequence in advance of the tests or medical procedures.

20. The diagnostic system of claim 17, further comprising means for displaying connected to the means for processing to display the list of test requirements including a certification of aptitude levels of a user with regard to the test of sequence of medical procedures.

21. The diagnostic system of claim 17, wherein the list of test requirements includes medical instruments, implants, medical equipment, facilities and training.

22. The diagnostic system of claim 17, wherein the list of test requirements include a cost of the test requirement.
